(19) United States
(12) Patent Application Publication
(10) Pub. No.: US 2009/0054588 A1
(43) Pub. Date: Feb. 26, 2009

(54) Fluoride-modified additive for cementitious products, process for its preparation and use thereof

(76) Inventors: Alois Maier, Engelsberg (DE); Norbert Steidl, Kienberg (DE); Johann Huber, Traunwalchen (DE); Christian Huber, Trostberg (DE); Marita Staudhammer, Feichteu (DE)

Correspondence Address: FULBRIGHT & JAWORSKI, LLP, 666 FIFTH AVE, NEW YORK, NY, 10103-3198, US

(21) Appl. No.: 12/279,605

(22) PCT Filed: Mar. 9, 2007
(86) PCT No.: PCT/EP2007/002094

§ 371 Date: Oct. 6, 2008

(30) Foreign Application Priority Data
Mar. 10, 2006 (DE) 10 2006 011 153.2

(51) Int. Cl. C04B 28/02

(52) U.S. Cl. 524/650; 525/410

(57) ABSTRACT

A fluoromodified admixture containing isocyanate and urethane and/or urea groups is described. Surprisingly, it has been found that the fluoromodified admixture according to the invention is outstandingly suitable even at a very low dosage for the permanent hydrophobic and/or oleophobic and/or dirt-repellent in-bulk finishing of products based on inorganic or hydraulic or mineral binders, without the fundamental property profile (e.g. compressive and flexural tensile strengths) of these products being substantially influenced. Moreover, it was not to be foreseen that in the case of the products treated with the fluoromodified admixtures according to the invention (e.g. hardened building material compositions) a markedly lower water absorption (avoidance of frost damage and corrosion) and a suppression of bleeding on the surfaces (avoidance of visual impairment) are to be observed. Furthermore, it could not be expected that in spite of the high fluorine modification an adequate self-dispersibility is afforded.

The present invention relates to a fluoromodified admixture, containing isocyanate and urethane and/or urea groups, a process for its preparation and its use as a liquid or powdery admixture or dispersant for aqueous suspensions based on hydraulic or mineral binders.

In DE 196 54 429 A1, the use of nonionically modified water-dispersible polyisocyanate mixtures containing aliphatically and/or cycloaliphatically bonded isocyanate groups as admixtures for inorganic binders in the production of highly dense or highly solid mortar compositions or concrete is described.

From DE 197 40 454 A1, it is known to use water-dispersible or water-soluble polyether urethanes optionally containing isocyanate groups as admixtures for inorganic binders in the production of highly dense or highly solid mortar compositions or concrete.

The admixtures based on hydrophilically modified polyisocyanates described in DE 196 54 429 A1 and in DE 197 40 454 A1 are in each case not fluoromodified and therefore unsuitable per se for hydrophobization and oleophobization of products based on inorganic or hydraulic or mineral binders.

According to DE 100 08 150 A1, mixtures for the production of ultraphobic coatings obtainable by combination of water-dispersible isocyanates, finely divided particulate materials and lacquer auxiliaries and water are disclosed. The water-dispersible isocyanates used are obtainable by reaction of polyisocyanates, monofunctional polyethers, fluorinated alcohols and, if appropriate, further auxiliaries and additives.

The water-dispersible isocyanates known from DE 100 08 150 A1 and DE 197 40 454 A1, however, are not intended for hydrophobization and oleophobization of products based on inorganic or hydraulic or mineral binders.

The use of silanes of all types for the mass hydrophobization of concrete and (dry) mortar systems has already been known for a relatively long time. The silanes customarily used here, however, do not have oleophobic properties and cannot be employed in solid form.

For ultraphobic in-bulk finishing of products based on inorganic or hydraulic or mineral binders, both hydrophobic and oleophobic properties must be combined.

The present invention was therefore based on the object of developing for production a fluoromodified admixture having improved processing properties and an improved property profile, which does not have said disadvantages of the prior art, but possesses good application technology properties and can at the same time be prepared taking into account ecological, economic and physiological aspects.

This object was achieved according to the invention by the provision of a fluoromodified admixture having a mean isocyanate functionality <3, a content of aliphatic or (cyclo)aliphatic isocyanate groups of 0.1 to 10% by weight (calculated as NCO of molecular mass=42.02 Dalton), a content of urethane groups and/or urea groups (calculated as NH—CO—O or NH—CO—NH having molecular mass 59.02 or 58.04 Dalton) of 2.5 to 25% by weight, a polymer bound fluorine content of 0.5 to 60% by weight and a content of ethylene oxide monomers bound within polymer chains (calculated as C₂H₄O of molecular mass=44.05 Dalton) of 30 to 90% by weight, comprising
(i) a₁) 1 to 100 parts by weight of at least one fluoromodified hydrophobization and oleophobization component (A), which is in particular polymeric, having a polymer bound fluorine content of 0.5 to 90% by weight, a content of free and/or blocked, in particular blocked isocyanate of 0.5 to 50% by weight, one or more (cyclo)aliphatic and/or aromatic isocyanate groups and a molecular mass of 275 to 100 000 Dalton of the general formula (I)

[CF₃—(CF₂)ₓ—(CH₂)_{y}]ₘ—R¹—(NCO)ₙ (I)

and/or (II)

[CF₃—(CF₂)ₓ—(CH₂)_{y}—O-A_{z}]ₘ—R¹—(NCO)ₙ (II)

and/or (III)

[CF₃—CF₂—CF₂—(O—CF(CF₃)—CF₂)ₓ—O—CF(CF₃)]ₘ—R¹—(NCO)ₙ (III)
where
x=3 to 20,
y=1 to 6,
z=1 to 100,
m=1 to 3,
n=1 to 6,
R¹=an inorganic and/or organic, (cyclo)aliphatic and/or aromatic and optionally polymeric radical having 1 to 100 C atoms and 0 to 100 N atoms and/or 0 to 100 O atoms and/or 0 to 100 Si atoms, A=CRⁱRⁱⁱ—(CRⁱⁱⁱR^{iv})ₚ—O,
Rⁱ, Rⁱⁱ, Rⁱⁱⁱ, R^{iv}=independently of one another H, a (cyclo)aliphatic and/or aromatic organic radical having 1 to 20 C atoms, and p=1 to 20, in particular 1 to 5, more preferably 1, where the polyalkylene oxide structural unit A_{z} is homopolymers, copolymers or block copolymers of any desired alkylene oxides,
and
b₁) 1 to 100 parts by weight of at least one water-dispersible or water soluble hydrophilization component (B), which is in particular polymeric, having a polymer bound ethylene oxide content of 0.5 to 90% by weight, an isocyanate content of 0.5 to 50% by weight, one or more (cyclo)aliphatic and/or aromatic isocyanate groups and a molecular mass of 101 to 100 000 Dalton of the general formula (IV)

(R³—O-A_{z′})_{m′}—R²—(NCO)_{n′} (IV)
where
z′=1 to 50,
m′=1 to 3,
n′=1 to 6,
R²=an inorganic and/or organic, (cyclo)aliphatic and/or aromatic and optionally polymeric radical having 1 to 100 C atoms and 0 to 100 N atoms and/or 0 to 100 O atoms and/or 0 to 100 Si atoms,
R³═H, a (cyclo)aliphatic and/or aromatic organic radical having 1 to 20 C atoms
and optionally
c₁) 1 to 100 parts by weight of at least one fluoromodified and amphiphilic hydrophobization and oleophobization component (C), which is in particular polymeric, having a polymer bound fluorine content of 0.5 to 90% by weight, a polymer bound ethylene oxide content of 0.5 to 90% by weight, a content of free and/or blocked, in particular blocked isocyanate of 0.5 to 50% by weight, one or more (cyclo)aliphatic and/or aromatic isocyanate groups and a molecular mass of 275 to 100 000 Dalton of the general formula (V)

[(CF₃—(CF₂)ₓ—(CH₂)_{y})]ₘ(R³—O-A_{z′})_{m′}-R⁴—(NCO)_{n″} (V)

and/or (VI)

[(CF₃—(CF₂)ₓ—(CH₂)_{y})—O-A_{z}]ₘ(R³—O-A_{z′})_{m′}-R⁴—(NCO)_{n″} (VI)

and/or (VII)

[CF₃—CF₂—CF₂—(O—CF(CF₃)—CF₂)ₓ—O—CF(CF₃)]ₘ(R³—O-A_{z′})_{m′}—R⁴—(NCO)_{n″} (VII)
where
n″=1 to 6,
R⁴=an inorganic and/or organic, (cyclo)aliphatic and/or aromatic and optionally polymeric radical having 1 to 100 C atoms and 0 to 100 N atoms and/or 0 to 100 O atoms and/or 0 to 100 Si atoms and
R³, m, m′, x, y and A_{z′} possess the abovementioned meaning
and optionally
d₁) 1 to 50 parts by weight of at least one polyisocyanate component (D), consisting of at least one diisocyanate, polyisocyanate, polyisocyanate derivative or polyisocyanate homologs having two or more (cyclo)aliphatic and/or aromatic isocyanate groups and a molecular mass of 100 to 2500 Dalton,
   or
   (ii) a₂) 1 to 100 parts by weight of at least one component (A) and
c₂) 1 to 100 parts by weight of at least one component (C) and
d₂) optionally 1 to 50 parts by weight of at least one component (D)
   or
   (iii) b₃) 1 to 100 parts by weight of at least one component (B) and
c₃) 1 to 100 parts by weight of at least one component (C) and
d₃) optionally 1 to 50 parts by weight of at least one component (D)
   or
   (iv) c₄) 1 to 100 parts by weight of at least one component (C) and
d₄) 1 to 50 parts by weight of at least one component (D)
   and
e) 0 to 100 parts by weight of at least one water-dispersible or water-soluble, hydrophobic or amphiphilic antiefflorescence component (E), comprising 10 to 90% by weight of a (polymer) bound fatty acid ester having two or three hydroxyl groups based on (un)saturated fatty acids and (cyclo)aliphatic or aromatic epoxy resins or polyepoxides having two or three epoxy groups reactive to fatty acids and a molecular mass of 500 to 50 000 Dalton or 1,2-dihydroxyalkanediols having 5 to 50 carbon atoms having two hydroxyl groups reactive to polyisocyanates and 90 to 10% by weight of further (polymer bound) constituents,
   f) 0 to 50 parts by weight of a catalyst component (K),
   g) 0 to 50 parts by weight of a solvent component (L), and
   h) 0 to 50 parts by weight of a formulation component (F).

Surprisingly, it has been found that the fluoromodified admixtures according to the invention are outstandingly suitable even at a very low dosage for the permanent hydrophobic and/or oleophobic and/or dirt-repellent in-bulk finishing of products based on inorganic or hydraulic or mineral binders, without the fundamental property profile (e.g. compressive and flexural tensile strength) of these products being substantially influenced. Moreover, it was not to be foreseen that in the case of products (e.g. hardened building material compositions) based on the fluoromodified admixtures according to the invention a markedly lower water absorption (avoidance of frost damage and corrosion) and a suppression of bleeding on the surfaces (avoidance of visual impairment) is to be observed. Furthermore, it could not be expected that in spite of the high fluoromodification an adequate self-dispersibility is afforded. As a result of the thereby strongly liquefying action of the fluoromodified admixtures according to the invention, the water/cement value (W/C value) in the case of modified concrete or (dry) mortar systems is markedly lower than in the case of unmodified concrete or (dry) mortar systems.

According to the present invention, component (A) preferably consists of
a_{1.1}) reaction products having at least one free isocyanate group, prepared from a(n) (alkoxylated) (per)fluoroalkylalkylenamine component (A)(i) and/or a(n) (alkoxylated) (per)fluoroalkylalkylene alcohol component (A)(ii) having an amino and/or a hydroxyl group and a polyisocyanate component (D) having (on average), 1.5 to 2.5, in particular two (cyclo)aliphatic and/or aromatic isocyanate groups, the reaction preferably being carried out in the molar ratio 0.9:1 to 1.1:1, in particular 1:1,
   or
a_{1.2}) reaction products having at least one free isocyanate group, prepared from a(n) (alkoxylated) (per)fluoroalkylalkylenamine component (A)(i) and/or a(n) (alkoxylated) (per)fluoroalkylalkylene alcohol component (A)(ii) having an amino and/or a hydroxyl group and a polyisocyanate component (D) having (on average) 2.5 to 3.5, in particular three (cyclo)aliphatic and/or aromatic isocyanate groups, the reaction preferably being carried out in the molar ratio 0.9:1 to 2.1:1, in particular 0.9:1 to 1.1:1, preferably 1:1 or in particular 1.9:1 to 2.1:1, preferably 2:1,
   or
a_{1.3}) reaction products having at least one free isocyanate group, prepared from a(n) (alkoxylated) (per)fluoroalkylalkylenamine component (A)(i) and/or a(n) (alkoxylated) (per)fluoroalkylalkylene alcohol component (A)(ii) having an amino and/or a hydroxyl group and a polyisocyanate component (D) having (on average) more than three (cyclo)aliphatic and/or aromatic isocyanate groups, the reaction preferably being carried out in the molar ratio≧0.9:1, in particular 0.9:1 to 3.1:1, preferably 0.9:1 to 1.1:1, in particular 1:1 or preferably 1.9:1 to 2.1:1, in particular 2:1 or preferably ≧3:1,
   or suitable combinations thereof are employed, it preferably being possible for perfluoroalkylalkylene alcohols having terminal methylene groups (hydrocarbon spacers) of the general formula (VIII)

CF₃—(CF₂)ₓ—(CH₂)_{y}—OH (VIII)
or alkoxylated perfluoroalkylalkylene alcohols of the general formula (IX)

CF₃—(CF₂)ₓ—(CH₂)_{y}—O-A_{z}-H (IX)
(having said meaning of x, y and A_{z})
or suitable combinations thereof, it being possible to employ technical (isomer) mixtures of diisocyanates, triisocyanates, polyisocyanates, polyisocyanate derivatives or polyisocyanate homologs and for the reaction products a_{1.1}) to a_{1.3}) additionally to contain free diisocyanates, triisocyanates, polyisocyanates, polyisocyanate derivatives or polyisocyanate homologs.

Component (B) according to the invention preferably consists of
b_{1.1}) reaction products having at least one free isocyanate group, prepared from a monofunctional polyoxyalkylenamine component (B)(i) and/or a monofunctional polyalkylene glycol component (B)(ii) having an amino and/or hydroxyl group and a polyisocyanate component (D) having (on average) two (cyclo)aliphatic and/or aromatic isocyanate groups, the reaction preferably being carried out in the molar ratio 0.9:1 to 1.1:1, in particular 1:1,
   or
b_{1.2}) reaction products having at least one free isocyanate group, prepared from a monofunctional polyoxyalkylenamine component (B)(i) and/or a monofunctional polyalkylene glycol component (B)(ii) having an amino and/or hydroxyl group and a polyisocyanate component (D) having (on average) 2.5 to 3.5, in particular three (cyclo)aliphatic and/or aromatic isocyanate groups, the reaction preferably being carried out in the molar ratio 0.9:1 to 2.1:1, in particular 0.9:1 to 1.1:1, preferably 1:1 or in particular 1.9:1 to 2.1:1, preferably 2:1,
   or
b_{1.3}) reaction products having at least one free isocyanate group, prepared from a monofunctional polyoxyalkylenamine component (B)(i) and/or a monofunctional polyalkylene glycol component (B)(ii) having an amino and/or hydroxyl group and a polyisocyanate component (D) having (on average) more than three (cyclo)aliphatic and/or aromatic isocyanate groups, the reaction preferably being carried out in the molar ratio≧0.9:1, in particular 0.9:1 to 3.1:1, preferably 0.9:1 to 1.1:1, in particular 1:1 or preferably 1.9:1 to 2.1:1, in particular 2:1 or preferably ≧3:1,
   or suitable combinations thereof, it being possible to employ technical (isomer) mixtures of diisocyanates, triisocyanates, polyisocyanates, polyisocyanate derivatives or polyisocyanate homologs and for the reaction products b_{1.1}) to b_{1.3}) additionally to contain free diisocyanates, triisocyanates, polyisocyanates, polyisocyanate derivatives or polyisocyanate homologs.

Component (C) according to the invention preferably consists of
c_{1.1}) reaction products having at least one free isocyanate group, prepared from a(n) (alkoxylated) (per)fluoroalkylalkylenamine component (A)(i) and/or a(n) (alkoxylated) (per)fluoroalkylalkylene alcohol component (A)(ii), a monofunctional polyoxyalkylenamine component (B)(i) and/or a monofunctional polyalkylene glycol component (B)(ii) having an amino and/or hydroxyl group and a polyisocyanate component (D) having (on average) 2.5 to 3.5, in particular three (cyclo)aliphatic and/or aromatic isocyanate groups, the reaction preferably being carried out in the molar ratio 1:1:1,
   or
c_{1.2}) reaction products having at least one free isocyanate group, prepared from a(n) (alkoxylated) (per)fluoroalkylalkylenamine component (A)(i) and/or a(n) (alkoxylated) (per)fluoroalkylalkylene alcohol component (A)(ii), a monofunctional polyoxyalkylenamine component (B)(i) and/or a monofunctional polyalkylene glycol component (B)(ii) having an amino and/or hydroxyl group and a polyisocyanate component (D) having (on average) more than three (cyclo)aliphatic and/or aromatic isocyanate groups, the reaction preferably being carried out in the molar ratio≧1:≧1:1,
   or suitable combinations thereof, it being possible to employ technical (isomer) mixtures of diisocyanates, triisocyanates, polyisocyanates, polyisocyanate derivatives or polyisocyanate homologs and for the reaction products c_{1.1}) to c_{1.2}) additionally to contain free diisocyanates, triisocyanates, polyisocyanates, polyisocyanate derivatives or polyisocyanate homologs.

A suitable (per)fluoroalkylalkylenamine component (A)(i) which can be employed is, for example, 3,3,4,4,5,5,6,6,7,7,8,8,8-tridecafluorooctylamine, 3,3,4,4,5,5,6,6,7,7,8,8,9,9,10,10,10-heptadecafluorodecylamine, 3,3,4,4,5,5,6,6,7,7,8,8,9,9,10,10,11,11,12,12,12-heneicosafluorododecylamine, 3,3,4,4,5,5,6,6,7,7,8,8,9,9,10,10,11,11,12,12,13,13,14,14,14-pentacosafluorotetradecylamine, 3,3,4,4,5,5,6,6,7,7,8,8,9,9,10,10,11,11,12,12,13,13,14,14,15,15,16,16,16-nonacosafluorohexadecylamine, reaction products of 1,1,1,2,2,3,3,4,4,5,5,6,6-tridecafluoro-8-iodoctane, 1,1,1-2,2,3,3,4,4,5,5,6,6,7,7,8,8-heptadecafluoro-10-iododecane, 1,1,1,2,2,3,3,4,4,5,5,6,6,7,7,8,8,9,9,10,10-heneicosafluoro-12-iodododecane, 1,1,1,2,2,3,3,4,4,5,5,6,6,7,7,8,8,9,9,10,10,11,11,12,12-pentacosafluoro-14-iodotetradecane, 1,1,1,2,2,3,3,4,4,5,5,6,6,7,7,8,8,9,9,10,10,11,11,12,12,13,13,14,14-nonacosafluoro-16-iodohexadecane, the commercial products Fluowet® I 600, Fluowet® I 800, Fluowet® I 612, Fluowet® I 812, Fluowet® I 6/1020, Fluowet® I 1020, consisting of perfluoroalkyl iodide mixtures, Fluowet® EI 600, Fluowet® EI 800, Fluowet® EI 812, Fluowet® EI 6/1020, consisting of perfluoroalkylethyl iodide mixtures, from Clariant GmbH and suitable aminating reagents or suitable combinations thereof. Preferably, perfluoroalkylethanol mixtures containing 30-49.9% by weight of 3,3,4,4,5,5,6,6,7,7,8,8,8-tridecafluorooctylamine and 30-49.9% by weight of 3,3,4,4,5,5,6,6,7,7,8,8,9,9,10,10,10=heptadecafluorodecylamine are used.

A suitable (per)fluoroalkyl alcohol component (A)(ii) which can be employed is, for example, 3,3,4,4,5,5,6,6,7,7,8,8,8-tridecafluorooctan-1-ol, 3,3,4,4,5,5,6,6,7,7,8,8,9,9,10,10,10-heptadecafluorodecan-1-ol, 3,3,4,4,5,5,6,6,7,7,8,8,9,9,10,10,11,11,12,12,12-heneicosafluorododecan-1-ol, 3,3,4,4,5,5,6,6,7,7,8,8,9,9,10,10,11,11,12,12,13,13,14,14,14-pentacosafluorotetradecan-1-ol, 3,3,4,4,5,5,6,6,7,7,8,8,9,9,10,10,11,11,12,12,13,13,14,14,15,15,16,16,16-nonacosafluorohexadecan-1-ol, 3,3,4,4,5,5,6,6,7,7,8,8-dodecafluoroheptan-1-ol, 3,3,4,4,5,5,6,6,7,7,8,8,9,9,10,10-hexadecafluorononan-1-ol, 3,3,4,4,5,5,6,6,7,7,8,8,9,9,10,10,11,11,12,12-eicosafluoroundecan-1-ol, 3,3,4,4,5,5,6,6,7,7,8,8,9,9,10,10,11,11,12,12,13,13,14,14-tetracosafluorotridecan-1-ol, 3,3,4,4,5,5,6,6,7,7,8,8,9,9,10,10,11,11,12,12,13,13,14,14,15,15,16,16-octacosafluoropentadecan-1-ol, the commercial products Fluowet® EA 600, Fluowet® EA 800, Fluowet® EA 093, Fluowet® EA 612, Fluowet® EA 612 N, Fluowet® EA 812 AC, Fluowet® EA 812 IW, Fluowet® EA 812 EP, Fluowet® EA 6/1020, consisting of perfluoroalkylethanol mixtures, Fluowet® OTL, Fluowet® OTN, consisting of ethoxylated perfluoroalkylethanol mixtures, from Clariant GmbH, the commercial products Zonyl® BA, Zonyl® BA L, Zonyl® BA LD, consisting of perfluoroalkylethanol mixtures, Zonyl® OTL, Zonyl® OTN, consisting of ethoxylated perfluoroalkylethanol mixtures, Zonyl® FSH, Zonyl® FSO, Zonyl® FSN, Zonyl® FS-300, Zonyl® FSN-100, Zonyl® FSO-100 from Du Pont de Nemours, the commercial products Krytox® from Du Pont de Nemours, consisting of hexafluoropropene oxide (HFPO) oligomer-alcohol mixtures, or suitable combinations thereof. Preferably, perfluoroalkylethanol mixtures containing 30-49.9% by weight of 3,3,4,4,5,5,6,6,7,7,8,8,8-tridecafluorooctan-1-ol and 30-49.9% by weight of 3,3,4,4,5,5,6,6,7,7,8,8,9,9,10,10,10-heptadecafluorodecan-1-ol such as the commercial products Fluowet® EA 612 and Fluowet® EA 812 are used.

A suitable monofunctional polyoxyalkylenamine component (B)(i) which can be employed is, for example, monoaminofunctional alkyl/cycloalkyl/aryl-polyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) containing 25 to 99.9% by weight of ethylene oxide and 0 to 75% by weight of a further alkylene oxide having 3 to 20 C atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 C atoms per alkylene oxide or mixtures thereof, the commercial products JEFFAMINE® M-600, JEFFAMINE® M-1000, JEFFAMINE® M-2005, JEFFAMINE® M-2070, consisting of monofunctional polyoxyalkylenamines based on ethylene oxide and propylene oxide, from Huntsman or suitable combinations thereof.

A suitable monofunctional polyalkylene glycol component (B)(ii) which can be employed is, for example, monohydroxyfunctional alkyl/cycloalkyl/aryl-polyethylene glycols and/or alkyl/cycloalkyl/arylpoly(ethylene oxide-block-alkylene oxide) and/or alkyl/cycloalkyl/arylpoly(ethylene oxide-co-alkylene oxide) and/or alkyl/cycloalkyl/arylpoly(ethylene oxide-ran-alkylene oxide) containing 25 to 99.9% by weight of ethylene oxide and 0 to 75% by weight of a further alkylene oxide having 3 to 20 C atoms, consisting of propylene oxide, butylene oxide, dodecyl oxide, isoamyl oxide, oxetane, substituted oxetanes, α-pinene oxide, styrene oxide, tetrahydrofuran or further aliphatic or aromatic alkylene oxides having 4 to 20 C atoms per alkylene oxide or mixtures thereof, the commercial products M 250, M 350, M 350 PU, M 500, M 500 PU, M 750, M 1100, M 2000 S, M 2000 FL, M 5000 S, M 5000 FL, consisting of mono-functional methylpolyethylene glycol, B11/50, B11/70, B11/100, B11/150, B11/150 K, B11/300, B11/700, consisting of monofunctional butylpoly-(ethylene oxide-ran-propylene oxide), from Clariant GmbH, the commercial product LA-B 729, consisting of monofunctional methylpoly(ethylene oxide-block/co-propylene oxide), from Degussa AG or suitable combinations thereof.

Components (B)(i) and (B)(ii) are accessible by alkoxylation of suitable monofunctional starter molecules. Suitable starter molecules which can be employed are, for example, methanol, ethanol, 1-propanol, 2-propanol, ethylene glycol monomethyl ether, diethylene glycol monomethyl ether or suitable combinations thereof. Component (B)(i) is accessible by amination of a suitable component (B)(ii).

A suitable polyisocyanate component (D) which can be employed is, for example, poly-isocyanates, polyisocyanate derivatives or polyisocyanate homologs having two or more aliphatic and/or aromatic isocyanate groups of identical or different reactivity or suitable combinations thereof. In particular, the polyisocyanates or combinations thereof adequately known in polyurethane chemistry are suitable. Suitable aliphatic polyisocyanates which can be employed are, for example, 1,6-diisocyanatohexane (HDI), 1-isocyanato-5-isocyanatomethyl-3,3,5-trimethylcyclohexane or isophorone diisocyanate (IPDI, commercial product VESTANAT® IPDI from Degussa AG), bis(4-isocyanatocyclohexyl)methane (H₁₂MDI, commercial product VESTANAT® H12MDI from Degussa AG), 1,3-bis(1-isocyanato-1-methylethyl)benzene (m-TMXDI). 2,2,4-trimethyl-1,6-diisocyanatohexane or 2,4,4-trimethyl-1,6-diisocyanatohexane (TMDI, commercial product VESTANAT® TMDI from Degussa AG), diisocyanates based on dimer fatty acid (commercial product DDI® 1410 DIISOCYANATE from Cognis Germany GmbH & Co. KG) or technical isomer mixtures of the individual aliphatic polyisocyanates. Suitable aromatic polyisocyanates which can be employed are, for example, 2,4-diisocyanatotoluene or toluene diisocyanate (TDI), bis(4-isocyanatophenyl)methane (MDI) and its higher homologs (polymeric MDI) or technical isomer mixtures of the individual aromatic polyisocyanates. Furthermore, the “lacquer polyisocyanates” based on bis(4-isocyanatocyclohexyl)methane (H₁₂MDI), 1,6-diisocyanatohexane (HDI) or 1-isocyanato-5-isocyanatomethyl-3,3,5-trimethylcyclohexane (IPDI) are also basically suitable. The term “lacquer polyisocyanates” characterizes derivatives of these diisocyanates containing allophanate, biuret, carbodiimide, iminooxadiazine-dione, isocyanurate, oxadiazinetrione, uretdione and urethane groups, in which the radical content of monomeric diisocyanates according to the prior art has been reduced to a minimum. In addition, modified polyisocyanates can also be employed, which are accessible, for example, by hydrophilic modification of “lacquer polyisocyanates” based on 1,6-diisocyanatohexane (HDI) with monohydroxy-functional polyethylene glycols or aminosulfonic acid sodium salts. Suitable “lacquer polyisocyanates” which can be used are, for example, the commercial products VESTANAT® T 1890 E, VESTANAT® T 1890 L, VESTANAT® T 1890 M, VESTANAT® T 1890 SV, VESTANAT®T 1890/100 (polyisocyanates based on IPDI trimer), VESTANAT® HB 2640 MX, VESTANAT® HB 2640/100, VESTANAT® HB 2640/LV (polyisocyanates based on HDI biuret), VESTANAT® HT 2500 L, VESTANAT® HB 2500/100, VESTANAT® HB 2500/LV (polyisocyanates based on HDI isocyanurate) from Degussa AG, the commercial product Basonat® HW 100 from BASF AG, the commercial products Bayhydur® 3100, Bayhydur® VP LS 2150 BA, Bayhydur® VP LS 2306, Bayhydur® VP LS 2319, Bayhydur® VP LS 2336, Bayhydur® XP 2451, Bayhydur® XP 2487, Bayhydur® XP 2487/1, Bayhydur® XP 2547, Bayhydur® XP 2570, Desmodur® XP 2565 from Bayer AG, the commercial products Rhodocoat® X EZ-M 501, Rhodocoat® X EZ-M 502, Rhodocoat® WT 2102 from Rhodia. Preferably, bis(4-isocyanatophenyl)methane (MDI) and its higher homologs (polymeric MDI) and derivatives and/or (hydrophilically modified) “lacquer polyisocyanates” containing allophanate, biuret, carbodiimide, iminooxadiazinedione, isocyanurate, oxadiazinetrione, uretdione and urethane groups based on bis(4-isocyanatocyclohexyl)methane (H₁₂MDI), 1,6-diiso-cyanatohexane (HDI), 1-isocyanato-5-isocyanatomethyl-3,3,5-trimethylcyclo-hexane (IPDI) or suitable combinations thereof can be employed.

Component (E) according to the invention consists preferably of
e_{1.1}) reaction products (E)(i) having optionally free isocyanate groups, prepared from a fatty acid ester component (E)(i.i) having two hydroxyl groups reactive to polyisocyanates based on (un)saturated fatty acids having a carboxyl group reactive to epoxides and (cyclo)aliphatic or aromatic epoxy resins or polyepoxides having two epoxy groups reactive to fatty acids in the molar ratio 2:1, a polyisocyanate component (D) having two or more isocyanate groups and optionally a monofunctional polyoxyalkylenamine component (B)(i) and/or a monofunctional polyalkylene glycol component (B)(ii) having an amino and/or hydroxyl group
   or
e_{1.2}) reaction products (E)(ii) having optionally free isocyanate groups, prepared from a fatty acid ester component (E)(ii.i) having two hydroxyl groups reactive to polyisocyanates based on (un)saturated fatty acids having a carboxyl group reactive to epoxides and (cyclo)aliphatic or aromatic epoxy resins or polyepoxides having three epoxy groups reactive to fatty acids in the molar ratio 3:1, a polyisocyanate component (D) having two or more isocyanate groups and optionally a monofunctional polyoxyalkylenamine component (B)(i) and/or a monofunctional polyalkylene glycol component (B)(ii) having an amino and/or hydroxyl group
   or
e_{1.3}) reaction products (E)(iii) having optionally free isocyanate groups, prepared from a 1,2-dihydroxyalkanediol component (E)(iii.i) having 5 to 50 carbon atoms of the general formula (X)

CₙH₂ₙ₊₁—CHOH—CH₂OH (X)
where
n=3 to 48
having two hydroxyl groups reactive to polyisocyanates, a polyisocyanate component (D) having two or more isocyanate groups and optionally a monofunctional polyoxyalkylenamine component (B)(i) and/or a monofunctional polyalkylene glycol component (B)(ii) having an amino and/or hydroxyl group, the reaction preferably being carried out in the molar ratio 1:2(:2), or suitable combinations thereof, it being possible to employ technical (isomer) mixtures of diisocyanates, triisocyanates, polyisocyanates, polyisocyanate derivatives or polyisocyanate homologs and for the reaction products e_{1.1}) to e_{1.3}) additionally to contain free diisocyanates, triisocyanates, polyisocyanates, polyisocyanate derivatives or polyisocyanate homologs.

Suitable reaction products (E)(i) and (E)(ii) which can be employed are, for example, the “antiefflorescence agents” adequately known from German patent applications DE 10 2005 030 828.7, DE 10 2005 034 183.7 and DE 10 2005 051 375.1 or suitable combinations thereof.

Suitable fatty acids esters (E)(i.i) and (E)(ii.i) which can be employed are, for example, the “antiefflorescence agents” adequately known from German patent application DE 10 2005 022 852.6 or suitable combinations thereof.

A suitable 1,2-dihydroxyalkanediol component (E)(iii.i) which can be employed is, for example, decane-1,2-diol, undecane-1,2-diol, dodecane-1,2-diol, tridecane-1,2-diol, tetradecane-1,2-diol, pentadecane-1,2-diol, hexadecane-1,2-diol, heptadecane-1,2-diol, octadecane-1,2-diol, nonadecane-1,2-diol, eicosane-1,2-diol, heneicosane-1,2-diol, docosane-1,2-diol, tricosane-1,2-diol, tetracosane-1,2-diol, pentacosane-1,2-diol, higher 1,2-diols or suitable combinations.

A suitable catalyst component (K) which can be employed is, for example, dibutyltin oxide, dibutyltin dilaurate (DBTL), triethylamine, tin(II) octoate, 1,4-diazabicyclo[2,2,2]octane (DABCO), 1,4-diazabicyclo[3,2,0]-5-nonene (DBN), 1,5-diazabicyclo[5,4,0]-7-undecene (DBU), morpholine derivatives such as, for example, JEFFCAT® Amine Catalysts or suitable combinations thereof.

A suitable solvent component (L) which can be employed is, for example, low-boiling solvents such as acetone or propanone, butanone, 4-methyl-2-pentanone, ethyl acetate, n-butyl acetate or high-boiling solvents such as N-methyl-2-pyrrolidone, N-ethyl-2-pyrrolidone, diethylene glycol dimethyl ether, dipropylene glycol dimethyl ether (Proglyde DMM®), ethylene glycol monoalkyl ether acetate, diethylene glycol monoalkyl ether acetate or suitable combinations thereof.

Moreover, a suitable solvent component (L) is, for example, plasticizers such as dialkyl adipates, dialkyl phthalates, cyclic alkylenecarbonates, biodiesel or rape-seed oil methyl ester or suitable combinations thereof.

A suitable formulation component (F) which can be employed is, for example, (functionalized) inorganic and/or organic fillers and/or light fillers, (functionalized) inorganic and/or organic nanoparticles, (functionalized) inorganic and/or organic pigments, (functionalized) inorganic and/or organic carrier materials, inorganic and/or organic fibers, graphite, carbon black, carbon fibers, carbon nanotubes, metal fibers and powders, conductive organic polymers, further polymeric and/or redispersible polymer powders, superabsorbers, antifoams, deaerators, lubricants and flow additives, substrate crosslinking additives, crosslinking and dispersant additives, hydrophobization agents, rheology additives, coalescence aids, matting compositions, adhesion promoters, antifreeze agents, antioxidants, UV stabilizers, biocides or suitable combinations thereof.

Suitable inorganic nanoparticles which can be employed are, for example, pyrogenic silica (SiO₂) such as AEROSIL® pyrogenic silicas, silicas doped with rare earths (RE) such as AEROSIL® pyrogenic silicas/RE, silver-doped pyrogenic silicas such as AEROSIL® pyrogenic silicas/Ag, silicon dioxide/aluminum oxide mixture (mullite) such as AEROSIL® pyrogenic silicas+Al₂O₃, silicon dioxide-titanium dioxide mixture such as AEROSIL® pyrogenic silicas+TiO₂, aluminum oxide (Al₂O₃) such as AEROXIDE® AluC, titanium dioxide (TiO₂) such as AEROXIDE® TiO₂ P25, zirconium dioxide (ZrO₂) VP zirconium oxide PH, yttrium-stabilized zirconium dioxide such as VP zirconium oxide 3YSZ, cerium dioxide (CeO₂) such as AdNano® Ceria, indium tin oxide (ITO, In₂O₃/SnO₂) such as Adnano® ITO, nanoscale iron oxide (Fe₂O₃) in a matrix of pyrogenic silica such as AdNano® MagSilica, zinc oxide (ZnO) such as AdNano® zinc oxide from Degussa AG or suitable combinations thereof. These nanoparticles can additionally be functionalized with amino- and/or epoxy- and/or isocyanato- and/or mercapto- and/or methacryloyl-functional silanes. In the case of amino-functional nanoparticles, a chemical compound can be prepared using the isocyanato-functional, fluoromodified admixture.

At least 50% by weight of the total inorganic nanoparticles have a particle size of 500 nm (Standard: DIN 53206-1, Prüfung von Pigmenten; Teilchengröβenanalyse, Grundbegriffe [Testing of Pigments; Particle Size Analysis, Basic Terms]) and the entirety of the particles which have this particle size of at most 500 nm have a specific surface area (Standard: DIN 66131, Bestimmung der spezifischen Oberfläche von Feststoffen durch Gasadsorption nach Brunauer, Emmet und Teller (BET) [Determination of the Specific Surface Area of Solids by Gas Adsorption According to Brunauer, Emmet and Teller (BET)]) of 10 to 200 m²/g.

At least 70% by weight, preferably at least 90% by weight, of the total inorganic nanoparticles have a particle size of 10 to 300 nm (Standard: DIN 53206-1, Prüfung von Pigmenten; Teilchengröβenanalyse, Grundbegriffe [Testing of Pigments; Particle Size Analysis, Basic Terms]) and the entirety of the particles which have this particle size of 10 to 300 nm have a specific surface area (Standard: DIN 66131, Bestimmung der spezifischen Oberfläche von Feststoffen durch Gasadsorption nach Brunauer, Emmet and Teller (BET) [Determination of the Specific Surface Area of Solids by Gas Adsorption According to Brunauer, Emmet and Teller (BET)]) of 30 to 100 m²/g.

A further subject of the present invention relates to a process for the preparation of the fluoromodified admixture according to the invention, which comprises, in stage
α₁) simultaneously or in succession preparing at least one hydrophobization and oleophobization component (A), at least one water-dispersible or water-soluble (polymeric) hydrophilization component (B) and optionally at least one fluoromodified and amphiphilic (polymeric) hydrophobization and oleophobization component (C), where optionally component (D) can additionally be present,
   or
α₂) simultaneously or in succession preparing at least one component (A) and at least one component (C), where optionally component (D) is additionally present,
   or
α₃) simultaneously or in succession preparing at least one component (B) and at least one component (C), where optionally component (D) is additionally present,
   or
α₄) preparing at least one component (C), where component (D) is additionally present,
   the preparation optionally being carried out in the presence of a catalyst component (K) and/or a solvent component (L) and the starting materials being added in any desired manner and the components then optionally being able to be mixed in any desired manner,
β) optionally mixing the mixture of components (A) and/or (B) and/or (C) and optionally (D) from stage α) with a water-dispersible or water-soluble, hydrophobic or amphiphilic antiefflorescence component (E) in any desired manner,
γ) optionally mixing the mixture of components (A) and/or (B) and/or (C) and optionally (D) from stages α) or β) with the formulation component (F) in any desired manner,
δ) optionally confectioning the mixture of components (A) and/or (B) and/or (C) and optionally (D) from stages α) or β) or γ) in a suitable manner,
ε) employing the mixture of components (A) and/or (B) and/or (C) and optionally (D) from stage δ) in a suitable manner and administration form as an admixture for inorganic or hydraulic or mineral binders.

The NCO/(OH+NH₍₂₎) equivalent ratio of the starting materials used for the preparation of components (A), (B) and (C) is preferably adjusted in reaction stage α) to 1.05 to 10, in particular to 1.5 to 5.

Reaction stage α) is carried out at a preferred temperature of 40 to 120° C., in particular of 60 to 100° C.

The polyisocyanate component (D) can be present after stages α) or β) or γ) in the form of residual monomers and/or be added separately.

According to a preferred embodiment, the water-emulsifiable, hydrophobic or amphiphilic antiefflorescence component (E) is already partially or completely added in stage α).

According to another preferred embodiment, the formulation component (F) is already partially or completely added in stage α).

The solvent component (L) cannot be removed or partially or completely distilled off after stages α) and/or β) and/or γ).

The mixture of components (A) and/or (B) and/or (C) and optionally (D) from stages α) or β) or γ) is present under standard conditions in solid, liquid and solvent-free or solvent-containing or (cryo)ground solid and solvent-free or solvent-containing and optionally additionally in blocked or coated or microencapsulated or carrier-immobilized form and can be employed as such.

The mean particle size of the mixture of components (A) and/or (B) and/or (C) and optionally (D) from stages α) or β) or γ) is adjusted to 10 to 10 000 μm, preferably to 100 to 1000 μm.

A further subject of the present invention relates to the use of the fluoromodified admixture according to the invention in the construction or industrial field for the permanent hydrophobic and/or oleophobic and/or dirt-repellent finishing of products based on inorganic or hydraulic or mineral binders.

The fluoromodified admixture according to the invention is suitable as a liquid or powdery additive or dispersant for aqueous suspensions based on inorganic or hydraulic or mineral binders, such as cement (Portland cement, Portland slag cement, Portland silica dust cement, Portland puzzolana cement, Portland fly ash cement, Portland shale cement, Portland limestone cement, Portland composite cement, blast furnace cement, puzzolana cement, composite cement, cement having a low heat of hydration, cement having high sulfate resistance, cement having low active alkali content), calcined lime, gypsum α-hemihydrate, β-hemihydrate, α/β-hemihydrate), anhydrite (natural anhydrite, synthetic anhydrite, REA anhydrite), geopolymers.

The fluoromodified admixture according to the invention can be used as a liquid or powdery additive or dispersant for concrete and (dry) mortar systems.

In this case, the fluoromodified admixture according to the invention can be employed in the form of liquid or powdery additives or dispersants in an amount of 0.01 to 10% by weight, preferably 0.1 to 5% by weight, based on the inorganic or hydraulic or mineral binder.

The fluoromodified admixture according to the invention can moreover be used in the form of liquid or powdery dispersants for inorganic and/or organic particles such as fillers, pigments, colorants and nanoparticles.

In this case, the fluoromodified admixture according to the invention can be employed in the form of liquid or powdery dispersants in an amount of 0.01 to 10% by weight, preferably 0.1 to 5% by weight, based on the amount of inorganic and/or organic particles.

The fluoromodified admixture according to the invention can be used in the construction or industrial field for the mass hydrophobization and/or oleophobization of concrete, such as, for example
job-mixed concrete
concrete products (manufactured and precast concrete)
building site concrete
shotcrete
ready-mixed concrete.

A further area of use of the fluoromodified admixture according to the invention in the construction or industrial field is the mass hydrophobization and/or oleophobization of construction products based on inorganic or hydraulic or mineral binders, such as, for example
construction adhesives and adhesives for EIFS
concrete repair systems
1 K and/or 2K waterproofing membranes
screeds, floor filler and self-levelling compounds
tile adhesives
joint mortars
gypsum and cement plasters
gypsum plasterboards
adhesives and sealants
PCC coating systems
repair mortars
filler compounds

The fluoromodified admixture according to the invention can moreover be used in the construction or industrial field for the hydrophobization and/or oleophobization of surfaces, such as, for example
“anti-graffiti” applications
“easy-to-clean” applications
compositions for “anti-graffiti” applications
compositions for “easy-to-clean” applications
paint and coating systems
PCC coating systems
building protection
corrosion protection
production of artificial stones
surface modification of fillers, nanoparticles and pigments.

Furthermore, the fluoromodified admixture according to the invention can be employed in the construction or industrial field as a mixture or combination with other concrete admixtures, such as, for example, superplasticizers, plasticizers, air entrainers, sealing compounds, retarders, accelerators, injection aids, stabilizers, chromate reducers, recycling aids for wash water.

Finally, the fluoromodified admixture according to the invention can also be used in the construction or industrial area as a mixture or combination with other concrete additives, such as, for example, trass, rock flour, coal fly ash, silica fume, pigments for staining concrete.

The application of the fluoromodified admixture according to the invention is carried out using the adequately known methods from construction chemistry.

The fluoromodified admixture according to the invention is added to the inorganic or hydraulic or mineral binder in solid or liquid form and/or in the entire amount or dispersed or dissolved in an aliquot of the addition water and/or added to the inorganic or hydraulic or mineral binder mixed with water. Optionally, the fluoromodified admixture according to the invention can also be dispersed or dissolved in residual water from fresh concrete recycling.

The addition of the fluoromodified admixture according to the invention can be carried out before and/or during and/or after the mixing of the inorganic or hydraulic or mineral binders.

In case of need, external emulsifiers (for example ethoxylated compounds, such as fatty acid ethoxylate, ethoxylated castor oil or ethoxylated fatty amine) can also be added.

On account of their outstanding emulsifiability, the fluoromodified admixtures according to the invention can also be stirred in very finely divided and in completely homogeneous form into concrete and (dry) mortar systems without special mixing units, such as, for example, high-speed stirrers.

The following examples are intended to illustrate the invention in more detail.

### EXAMPLES

### Example 1

100.00 g of a monohydroxyfunctional perfluoroalkyl alcohol (Fluowet® EA 612, OHC=127 mg_{KOH}/g, Clariant GmbH) are stirred with 90.54 g of an aromatic polyisocyanate based on MDI (DESMODUR® VL R 10, 31.5% by weight NCO, Bayer AG) in the presence of 0.05 g of dibutyltin dilaureate at 65° C. until the theoretical NCO content (9.98% by weight) is achieved. The cooled yellow-brown melt is subsequently carefully milled.

### Example 2

100.00 g of a monohydroxyfunctional perfluoroalkyl alcohol (Fluowet® EA 612, OHC=127 mg_{KOH}/g, Clariant GmbH) are stirred with 124.00 g of an aliphatic polyisocyanate based on HDI isocyanurate (VESTANAT® HT 2500/LV, 23.0% by weight NCO, Degussa AG) in the presence of 0.05 g of dibutyltin dilaureate at 75° C. until the theoretical NCO content (8.49% by weight) is achieved. The cooled yellow-brown melt is subsequently carefully milled.

### Example 3

100.00 g of a monohydroxyfunctional methylpolyethylene glycol (Polyglycol® M 2000 FL, OHC=56.1 mg_{KOH}/g, Clariant GmbH) are stirred with 20.01 g of an aromatic polyisocyanate based on MDI (DESMODUR®VL R 10, 31.5% by weight NCO, Bayer AG) in the presence of 0.05 g of dibutyltin dilaureate at 65° C. until the theoretical NCO content (3.50% by weight) is achieved. The cooled yellow-brown melt is subsequently carefully milled.

### Example 4

100.00 g of a monohydroxyfunctional methylpolyethylene glycol (Polyglycol® M 2000 FL, OHC=56.1 mg_{KOH}/g, Clariant GmbH) are stirred with 27.40 g of an aliphatic polyisocyanate based on HDI isocyanurate (VESTANAT® HT 2500/LV, 23.0% by weight NCO, Degussa AG) in the presence of 0.05 g of dibutyltin dilaureate at 75° C. until the theoretical NCO content (3.30% by weight) is achieved. The cooled yellow-brown melt is subsequently carefully milled.

### Example 5

### Fluoromodified Admixture

100.00 g of a monohydroxyfunctional perfluoroalkyl alcohol (Fluowet® EA 612, OHC=127 mg_{KOH}/g, Clariant GmbH) and 100.00 g of a monohydroxyfunctional methylpolyethylene glycol (Polyglycol® M 2000 FL, OHC=56.1 mg_{KOH}/g, Clariant GmbH) are stirred with 110.55 g of an aromatic polyisocyanate based on MDI (DESMODUR® VL R 10, 31.5% by weight NCO, Bayer AG) in the presence of 0.10 g of dibutyltin dilaureate at 65° C. until the theoretical NCO content (8.15% by weight) is achieved and after termination of the reaction a further 7.77 g of the polyisocyanate employed are added (theoretical NCO content: 8.72% by weight). The cooled yellow-brown melt is subsequently carefully milled.

### Example 6

### Fluoromodified Admixture

100.00 g of a monohydroxyfunctional perfluoroalkyl alcohol (Fluowet® EA 612, OHC=127 mg_{KOH}/g, Clariant GmbH) and 100.00 g of a monohydroxyfunctional methylpolyethylene glycol (Polyglycol® M 2000 FL, OHC=56.1 mg_{KOH}/g, Clariant GmbH) are stirred with 151.41 g of an aliphatic polyisocyanate based on HDI isocyanurate (VESTANAT® HT 2500/LV, 23.0% by weight NCO, Degussa AG) in the presence of 0.10 g of dibutyltin dilaureate at 75° C. until the theoretical NCO content (7.20% by weight) is achieved and after termination of the reaction a further 8.79 g of the polyisocyanate employed are added (theoretical NCO content: 7.59% by weight). The cooled yellow-brown melt is subsequently carefully milled.

### Example 7

629.8 g (2.1717 mol) of a tall oil fatty acid (Hanf & Nelles) and 369.2 g (1.0859 mol) of a bisphenol A diglycidyl ether (Polypox® E 270/500, UPPC AG) are heated to 150° C. in the presence of 1.0 g of tetrabutylammonium bromide (SIGMA-ALDRICH Chemie GmbH) under nitrogen protection. The mixture is stirred at this temperature for about 8 h until an acid number <2 is achieved.

80 g (0.0870 mol) of the fatty acid adduct are introduced at room temperature and treated with 4 drops of dibutyltin dilaureate. Subsequently, 20.1 g (0.1154 mol) of an aromatic polyisocyanate based on TDI (DESMODUR® T80, Bayer AG) are metered in during the course of 60 min at 60-70° C. The reaction mixture is stirred until the theoretical NCO content (2.42-2.38% by weight) is achieved. 114.8 g (0.0574 mol) of a monohydroxyfunctional methylpolyethylene glycol (Polyglycol® M 2000 FL, Clariant GmbH) are then metered in during the course of 60 min at 60-70° C. The reaction mixture is stirred until the NCO content has fallen to zero.

### Example 8

### Fluoromodified Admixture

47.65 g of the powdery product from Example 1 and 30.01 g of the powdery product from Example 3 are homogenized.

### Example 9

### Fluoromodified Admixture

56.01 g of the powdery product from Example 2 and 31.86 g of the powdery product from Example 4 are homogenized.

### Example 10

### Fluoromodified Admixture

23.82 g of the powdery product from Example 1 and 30.01 g of the powdery product from Example 3 are homogenized.

### Example 11

### Fluoromodified Admixture

28.01 g of the powdery product from Example 2 and 31.86 g of the powdery product from Example 4 are homogenized.

### Example 12

### Fluoromodified Admixture

47.65 g of the product from Example 1 and 30.01 g of the product from Example 3 are homogenized and subsequently mixed with 10.00 g of the product from Example 7.

### Example 13

### Fluoromodified Admixture

56.01 g of the product from Example 2 and 31.86 g of the product from Example 4 are homogenized and subsequently mixed with 10.00 g of the product from Example 7.

The admixtures according to the invention from Examples 5-6 and 8-13 were employed in a dosage of 0.3 or 0.5% by weight based on cement in the following concrete recipe (F6 concretes):

| | |
|---|---|
| Component | Amount |

| | | |
|---|---|---|
| GEM III 42.5 N Neuwied | 270.00 | kg |
| Quartz sand 0/0.5 | 76.00 | kg |
| Quartz sand 0/1.0 | 92.00 | kg |
| Sand 0/4 | 739.00 | kg |
| Gravel 4/8 | 378.00 | kg |
| Gravel 8/12 | 568.00 | kg |
| Glenium ® SKY 501¹⁾ | 2.59 | kg |
| Steament ® V-A/B²⁾ | 100.00 | kg |
| Water (w/c = 0.58) | 156.60 | kg |
| Additive from Exs. 5-6 and 8-13 | 0.81 kg or 1.35 | kg |
| Total: | 2383.00 kg or 2383.54 | kg |

¹⁾high-efficiency superplasticizer based on polycarboxylate, BASE Construction Chemicals GmbH
²⁾coal fly ash STEAG Entsorgungs-GmbH

Suitable testing specimen were produced from the individual mixtures.

### Example 14

The fluoromodified admixtures according to the invention from Examples 5-6 and 8-13 were employed in a dosage of 0.3% by weight or 0.5% by weight based on cement in the following mortar recipe (standard mortar):

| | |
|---|---|
| Component | Parts by weight |

| | | |
|---|---|---|
| CEM I 42.5 R Karlstadt | 450.00 | kg |
| Standard sand | 1350.00 | kg |
| MELFLUX ® 2453¹⁾ | 2.045 | kg |
| Water (w/c = 0.50) | 225.00 | kg |
| Additive from Exs. 5-6 and 8-13 | 1.35 kg or 2.25 | kg |
| Total: | 2028.395 kg or 2029.295 | kg |

¹⁾high-efficiency superplasticizer based on polycarboxylate, BASF Construction Chemicals GmbH

Suitable testing specimen were produced from the individual mixtures.

### Example 15

After hardening the testing specimen according to Examples 13 and 14 under standard conditions, water and oil applied in the form of drops no longer penetrates into the surface, moreover a decreased proneness to soiling is observed. The water-repellent effect for said liquids is very good. In the case of untreated testing specimen, said liquids immediately penetrate into the surface. The fluorine-containing admixtures are thus suitable in the construction or industrial field for the simultaneous hydrophobic and/or oleophobic and/or dirt-repellent finishing of products based on inorganic or hydraulic or mineral binders.

1-27. (canceled)

28. A fluoromodified admixture for cementitious products comprising
(i) a₁) 1 to 100 parts by weight of at least one fluoromodified (polymeric) hydrophobization and oleophobization component (A) having a polymer bound fluorine content of 0.5 to 90% by weight a (blocked) isocyanate content of 0.5 to 50% by weight, at least one of a (cyclo)aliphatic isocyante group or an aromatic isocyanate group, and a molecular mass of 275 to 100,000 Dalton of at least one of formula (I)
[CF₃—(CF₂)ₓ—(CH₂)_{y}]ₘ—R¹—(NCO)ₙ (I),
formula (II)
[CF₃—(CF₂)ₓ—(CH₂)_{y}—O-A_{z}]ₘ-R¹—(NCO)ₙ (II),
or formula (III)
[CF₃—CF₂—CF₂—(O—CF(CF₃)—CF₂)ₓ—O—CF(CF₃)]ₘ—R¹—(NCO)ₙ (III);
wherein
x is from 3 to 20;
y is from 1 to 6;
z is from 1 to 100;
m is from 1 to 3;
n is from 1 to 6;
R¹ is at least one of an inorganic or organic, (cyclo)aliphatic or aromatic radical and has from 1 to 100 C atoms, from 0 to 100 N atoms, from 0 to 100 O atoms and 0 to 100 Si atoms;
A is CRⁱRⁱⁱ—(CRⁱⁱⁱR^{iv})ₚ—O,
Rⁱ, Rⁱⁱ, Rⁱⁱⁱ, R^{iv} are independently selected from H, a (cyclo)aliphatic or aromatic organic radical having 1 to 20 C atoms, and p is 1 to 20, wherein the polyalkylene oxide structural unit A_{z} is a homopolymer, copolymer or block copolymer of an alkylene oxide;
and
b₁) 1 to 100 parts by weight of at least one water-emulsifiable or water-soluble (polymeric) hydrophilization component (B) having a polymer bound ethylene oxide content of 0.5 to 90% by weight, an isocyanate content of 0.5 to 50% by weight, at least one of a (cyclo)aliphatic isocyante group or an aromatic isocyanate group, and a molecular mass of from 101 to 100,000 Dalton of formula (IV)
(R³—O-A_{z′})_{m′}-R²—(NCO)_{n′} (IV)
wherein
z′ is from 1 to 50;
m′ is from 1 to 3;
n′ is from 1 to 6;
R² is at least one of an inorganic or organic, (cyclo)aliphatic or aromatic radical having from 1 to 100 C atoms, from 0 to 100 N atoms, from 0 to 100 O atoms and from 0 to 100 Si atoms;
R³ is from H, a (cyclo)aliphatic or aromatic organic radical having 1 to 20 C atoms;
and optionally
c₁) 1 to 100 parts by weight of at least one fluoromodified and amphiphilic (polymeric) hydrophobization and oleophobization component (C) having a polymer bound fluorine content of 0.5 to 90% by weight, a polymer bound ethylene oxide content of 0.5 to 90% by weight, a (blocked) isocyanate content of 0.5 to 50% by weight, at least one of a (cyclo)aliphatic or aromatic isocyanate group and a molecular mass of from 275 to 100,000 Dalton of formula (V);
[(CF₃—(CF₂)ₓ—(CH₂)_{y})]ₘ(R³—O-A_{z′})_{m′}-R⁴—(NCO)_{n″} (V),
or formula (VI)
[(CF₃—(CF₂)ₓ—(CH₂)_{y})—O-A_{z}]ₘ(R³—O-A_{z′})_{m′}-R⁴—(NCO)_{n″} (VI),
or formula (VII)
[CF₃—CF₂—CF₂—(O—CF(CF₃)—CF₂)ₓ—O—CF(CF₃)]ₘ(R³—O-A_{z′})_{m′}-R⁴—(NCO)_{n″} (VII);
wherein
n″ is from 1 to 6,
R⁴ is an inorganic or organic, (cyclo)aliphatic or aromatic radical having from 1 to 100 C atoms, from 0 to 100 N atoms, from 0 to 100 O atoms or and from 0 to 100 Si atoms; and
R³, m, m′, x, y and A_{z′} are as defined above,
and optionally
d₁) from 1 to 50 parts by weight of at least one polyisocyanate component (D), comprising at least one diisocyanate, polyisocyanate, polyisocyanate derivative or polyisocyanate homolog having two or more of (cyclo)aliphatic or aromatic isocyanate groups, or both (cyclo)aliphatic and aromatic isocyanate groups, and a molecular mass of 100 to 2,500 Dalton,
or
(ii) a₂) from 1 to 100 parts by weight of at least one component (A), and
c₂) from 1 to 100 parts by weight of at least one component (C), and
d₂) optionally from 1 to 50 parts by weight of at least one component (D),
or
(iii) b₃) from 1 to 100 parts by weight of at least one component (B), and
C₃) from 1 to 100 parts by weight of at least one component (C), and
d₃) optionally from 1 to 50 parts by weight of at least one component (D),
or
(iv) c₄) from 1 to 100 parts by weight of at least one component (C), and
d₄) 1 to 50 parts by weight of at least one component (D),
and
e) from 0 to 100 parts by weight of at least one water-emulsifiable, hydrophobic or amphiphilic antiefflorescence component (E), comprising 10 to 90% by weight of a (polymer) bound fatty acid ester having two or three hydroxyl groups based on (un)saturated fatty acids and (cyclo)aliphatic or aromatic epoxy resins or polyepoxides having two or three epoxy groups reactive to fatty acids and a molecular mass of from 500 to 50,000 Dalton or a 1,2-dihydroxyalkanediol having from 5 to 50 carbon atoms having two hydroxyl groups reactive to polyisocyanates and 90 to 10% by weight of further polymer bound constituents,
f) from 0 to 50 parts by weight of a catalyst component (K),
g) from 0 to 50 parts by weight of a solvent component (L), and
h) from 0 to 50 parts by weight of a formulation component (F):
wherein the fluoromodified admixture has a mean isocyanate functionality <3, a content of aliphatic or (cyclo)aliphatic isocyanate groups of 0.1 to 10% by weight, a content of at least one of urethane groups or urea groups of 2.5 to 25% by weight, a polymer bound fluorine content of 0.5 to 60% by weight and a content of ethylene oxide monomers bound within polyether chains of 30 to 90% by weight.

29. The admixture as claimed in claim 28, wherein component (A) comprises
a_{1.1}) a reaction product having at least one free isocyanate group, prepared from an (alkoxylated) (per)fluoroalkylalkylenamine (A)(i) or an (alkoxylated) (per)fluoroalkylalkylene alcohol (A)(ii) and a polyisocyanate component (D) selected from (cyclo)aliphatic or aromatic polyisocyanates, polyisocyanate derivatives or polyisocyanate homologs having, on average, two isocyanate groups;
or
a_{1.2}) a reaction product having at least one free isocyanate group, prepared from an (alkoxylated) (per)fluoroalkylalkylenamine (A)(i) or an (alkoxylated) (per)fluoroalkylalkylene alcohol (A)(ii) and a polyisocyanate component (D) selected from (cyclo)aliphatic or aromatic polyisocyanates, polyisocyanate derivatives or polyisocyanate homologs having on average three isocyanate groups;
or
a_{1.3}) a reaction product having at least one free isocyanate group, prepared from an (alkoxylated) (per)fluoroalkylalkylenamine (A)(i) or an (alkoxylated) (per)fluoroalkylalkylene alcohol (A)(ii) and a polyisocyanate component (D) selected from (cyclo)aliphatic or aromatic polyisocyanates, polyisocyanate derivatives or polyisocyanate homologs having more than three isocyanate groups;
or suitable combinations thereof,
wherein preferably perfluoroalkylalkylene alcohols having terminal methylene groups (hydrocarbon spacers) of formula (VIII)
CF₃—(CF₂)ₓ—(CH₂)_{y}—OH (VIII)
or alkoxylated perfluoroalkylalkylene alcohols of formula (IX)
CF₃—(CF₂)ₓ—(CH₂)_{y}—O-A_{z}-H (IX)
wherein x, y and A_{z} are as previously defined,
or suitable combinations thereof, technical (isomer) mixtures of diisocyanates, triisocyanates, polyisocyanates, polyisocyanate derivatives or polyisocyanate homologs are used and the reaction products a_{1.1}) to a_{1.3}) can optionally contain free diisocyanates, triisocyanates, polyisocyanates, polyisocyanate derivatives or polyisocyanate homologs.

30. The admixture as claimed in claim 28, wherein component (B) is
b_{1.1}) a reaction product having at least one free isocyanate group, prepared from at least one of a monofunctional polyoxyalkylenamine component (B)(i) or a monofunctional polyalkylene glycol component (B)(ii) having an amino or hydroxyl group and a polyisocyanate component (D) having on average two (cyclo)aliphatic and/or aromatic isocyanate groups;
or
b_{1.2}) a reaction product having at least one free isocyanate group, prepared from at least one of a monofunctional polyoxyalkylenamine component (B)(i) or a monofunctional polyalkylene glycol component (B)(ii) having an amino or hydroxyl group and a polyisocyanate component (D) having on average three (cyclo)aliphatic or aromatic isocyanate groups or a combination thereof;
or
b_{1.3}) reaction products having at least one free isocyanate group, prepared from at least one of a monofunctional polyoxyalkylenamine component (B)(i) or a monofunctional polyalkylene glycol component (B)(ii) having an amino or hydroxyl group and a polyisocyanate component (D) having on average more than three (cyclo)aliphatic or aromatic isocyanate groups or a combination thereof,
or suitable combinations thereof, technical (isomer) mixtures of diisocyanates, triisocyanates, polyisocyanates, polyisocyanate derivatives or polyisocyanate homologs and the reaction products b_{1.1}) to b_{1.3}) can optionally contain free diisocyanates, triisocyanates, polyisocyanates, polyisocyanate derivatives or polyisocyanate homologs.

31. The admixture as claimed in claim 28, wherein component (C) is
c_{1.1}) a reaction product having at least one free isocyanate group, prepared from a(n) (alkoxylated) (per)fluoroalkylalkylenamine component (A)(i) or a(n) (alkoxylated) (per)fluoroalkylalkylene alcohol component (A)(ii), a monofunctional polyoxyalkylenamine component (B)(i) or a monofunctional polyalkylene glycol component (B)(ii) having an amino or hydroxyl group and a polyisocyanate component (D) having on average three (cyclo)aliphatic or aromatic isocyanate groups or combinations thereof;
or
c_{1.2}) reaction products having at least one free isocyanate group, prepared from a(n) (alkoxylated) (per)fluoroalkylalkylenamine component (A)(i) or a(n) (alkoxylated) (per)fluoroalkylalkylene alcohol component (A)(ii), a monofunctional polyoxyalkylenamine component (B)(i) or a monofunctional polyalkylene glycol component (B)(ii) having an amino or hydroxyl group and a polyisocyanate component (D) having on average more than three (cyclo)aliphatic or aromatic isocyanate groups;
or suitable combinations thereof, technical (isomer) mixtures of diisocyanates, triisocyanates, polyisocyanates, polyisocyanate derivatives or polyisocyanate homologs and the reaction products c_{1.1}) to c_{1.2}) can optionally contain free diisocyanates, triisocyanates, polyisocyanates, polyisocyanate derivatives or polyisocyanate homologs.

32. The admixture as claimed in claim 28, wherein component (E) is
e_{1.1}) a reaction products (E)(i) having optionally free isocyanate groups, prepared from a fatty acid ester component (E)(i.i) having two hydroxyl groups reactive to polyisocyanates based on (un)saturated fatty acids having a carboxyl group reactive to epoxides and (cyclo)aliphatic or aromatic epoxy resins or polyepoxides having two epoxy groups reactive to fatty acids in the molar ratio 2:1, a polyisocyanate component (D) having two or more isocyanate groups and optionally a monofunctional polyoxyalkylenamine component (B)(i) or a monofunctional polyalkylene glycol component (B)(ii) having an amino or hydroxyl group;
or
e_{1.2}) reaction products (E)(ii) having optionally free isocyanate groups prepared from a fatty acid ester component (E)(ii.i) having two hydroxyl groups reactive to polyisocyanates based on (un)saturated fatty acids having a carboxyl group reactive to epoxides and (cyclo)aliphatic or aromatic epoxy resins or polyepoxides having three epoxy groups reactive to fatty acids in the molar ratio 3:1, a polyisocyanate component (D) having two or more isocyanate groups and optionally a monofunctional polyoxyalkylenamine component (B)(i) or a monofunctional polyalkylene glycol component (B)(ii) having an amino or hydroxyl group
or
e_{1.3}) reaction products (E)(iii) having optionally free isocyanate groups, prepared from a 1,2-dihydroxyalkanediol component (E)(iii.i) having 5 to 50 carbon atoms of formula (X)
CₙH₂ₙ₊₁—CHOH—CH₂OH (X)
wherein
n is from 3 to 48
having two hydroxyl groups reactive to polyisocyanates, a polyisocyanate component (D) having two or more isocyanate groups and optionally at least one of a monofunctional polyoxyalkylenamine component (B)(i) or a monofunctional polyalkylene glycol component (B)(ii) having an amino or hydroxyl group,
or suitable combinations thereof, technical (isomer) mixtures of diisocyanates, triisocyanates, polyisocyanates, polyisocyanate derivatives or polyisocyanate homologs and the reaction products e_{1.1}) to e_{1.3}) can optionally contain free diisocyanates, triisocyanates, polyisocyanates, polyisocyanate derivatives or polyisocyanate homologs.

33. The admixture as claimed in claim 28, wherein component (K) is dibutyltin oxide, dibutyltin dilaurate, triethylamine, tin(II) octoate, 1,4-diazabicyclo[2,2,2]octane, 1,4-diazabicyclo[3,2,0]-5-nonene, 1,5=diazabicyclo[5,4,0]-7-undecene or a morpholine derivative.

34. The admixture as claimed in claim 28, wherein component (L) is at least one low-boiling solvent selected from the group consisting of acetone, propanone, butanone, 4-methyl-2-pentanone, ethyl acetate, n-butyl acetate or high-boiling solvents such as N-methyl-2-pyrrolidone, N-ethyl-2-pyrrolidone, diethylene glycol dimethyl ether, dipropylene glycol dimethyl ether (Proglyde DMM®), ethylene glycol monoalkyl ether acetate, and diethylene glycol monoalkyl ether acetate.

35. The admixture as claimed in 38, wherein solvent component (L) comprises at least one plasticizer selected from the group consisting of dialkyl adipates, dialkyl phthalates, cyclic alkylenecarbonates, biodiesel and rapeseed oil methyl ester.

36. The admixture as claimed in claim 28, wherein component (F) comprises at least one of a (functionalized) inorganic or organic filler, a light fillers, a (functionalized) inorganic or organic nanoparticle, a (functionalized) inorganic or organic pigments, a (functionalized) inorganic or organic carrier material, an inorganic or organic fiber, graphite, carbon black, carbon fibers, carbon nanotubes, metal fibers and powders, a conductive organic polymer, further polymeric powder, a redispersible polymer powder, a superabsorber, antifoams, a deaerator, a lubricant, a flow additive, a substrate crosslinking additive, a crosslinking and a dispersant additive, a hydrophobization agent, a rheology additive, a coalescence aid, a matting composition, an adhesion promoter, an antifreeze agent, an antioxidant, an UV stabilizer or a biocide.

37. A process for the preparation of the fluoromodified admixture as claimed in claim 28, which comprises, in stage
α₁) simultaneously or in succession preparing at least one hydrophobization and oleophobization component (A), at least one water emulsifiable or water-soluble (polymeric) hydrophilization component (B) and optionally at least one fluoromodified and amphiphilic (polymeric) hydrophobization and oleophobization component (C), where optionally component (D) is additionally present,
or
α₂) simultaneously or in succession preparing at least one component (A) and at least one component (C), where optionally component (D) is additionally present,
or
α₃) simultaneously or in succession preparing at least one component (B) and at least one component (C), where optionally component (D) is additionally present,
or
α₄) preparing at least one component (C), where component (D) is additionally present and the preparation is optionally carried out in the presence of at least one of catalyst component (K) or a solvent component (L) and the starting materials are added in any desired manner and the components can then optionally be mixed;
β) optionally mixing the mixture of at least one of components (A), (B) (C) and optionally (D) from stage α) with a water-dispersible or water-soluble, hydrophobic or amphiphilic antiefflorescence component (E)
γ) optionally mixing the mixture of at least one of components (A) (B) (C) and optionally (D) from stages α) or β) with the formulation component (F),
δ) optionally confectioning the mixture of at least one of components (A) (B) (C) and optionally (D) from stages α) or β) or γ)
ε) employing the mixture of at least one of components (A) (B), (C) and optionally (D) from stage δ) in a suitable manner and administration form as an additive for hydraulic binders.

38. The process as claimed in claim 37, wherein the NCO/(OH+NH₍₂₎) equivalent ratio of starting materials used for the preparation of components (A), (B) and (C) is adjusted in reaction stage α) to 1.05 to 10.

39. The process as claimed in claim 37, wherein reaction stage α) is carried out at a temperature of 40 to 120° C.

40. The process as claimed in claim 37, wherein the polyisocyanate component (D) is present after stages α) or β) or γ) in the form of residual monomers.

41. The process as claimed in claim 37, wherein the water-emulsifiable, hydrophobic or amphiphilic antiefflorescence component (E) is already partially or completely added in stage α).

42. The process as claimed in claim 37, wherein the formulation component (F) is already partially or completely added in stage α).

43. The process as claimed in claim 37, wherein the solvent component (L) is partially or completely distilled off after at least one of stages α), β) or γ).

44. The process as claimed in claim 37, wherein the mixture of at least one of components (A), (B), (C) and optionally (D) from stages α) or β) or γ) is present and employed under standard conditions in solid, liquid and solvents free or solvent-containing or (cryo)ground solid and solvent-free or solvent-containing and optionally additionally in blocked or coated or microencapsulated or carrier-immobilized form.

45. The process as claimed in claim 37, wherein the mean particle size of the mixture of at least one of components (A), (B), (C) and optionally (D) from stages α) or β) or γ) is adjusted to 10 to 10,000 μm.

46. A composition comprising a mineral binder and the fluoromodified admixture as claimed in claim 28.

49. An aqueous suspension comprising the fluoromodified admixture as claimed in claim 28 as a liquid or powdery additive or dispersant in the aqueous suspension, wherein the aqueous suspension comprises at least one of cement, lime, α-hemihydrate, β-hemihydrate, α/β-hemihydrate, natural anhydrite, synthetic anhydrite or REA anhydrite.

50. A concrete or dry mortar system comprising the fluoromodified admixture as claimed in claim 28.

51. The composition of claim 49, wherein the liquid or powdery additives or dispersants are present in an amount of 0.01 to 10% by weight based on the binder.

52. The composition of claim 48, further comprising at least one of a filler, a pigment, a colorant or a nanoparticle.

53. A method for the mass hydrophobization or oleophobization of a construction mixture comprising adding the admixture of claim 28 to a binder.

54. The method of claim 53, wherein the hydrophobization/oleophobization wherein the binder is a mineral binder selected from the group consisting of cement, lime, α-hemihydrate, β-hemihydrate, α/β-hemihydrate, natural anhydrite, synthetic anhydrite and REA anhydrite.
